(19) United States
(12) Patent Application Publication
(10) Pub. No.: US 2024/0269666 A1
(43) Pub. Date: Aug. 15, 2024

(54) MICRODROPLET EJECTION APPARATUS

(71) Applicant: Seoul National University R&DB Foundation, Seoul (KR)

(72) Inventors: Ho-Young Kim, Seoul (KR); Hyun-Woo Kim, Seoul (KR)

(73) Assignee: Seoul National University R&DB Foundation, Seoul (KR)

(21) Appl. No.: 18/540,871

(22) Filed: Dec. 15, 2023

(30) Foreign Application Priority Data
Feb. 10, 2023 (KR) 10-2023-0018037

(51) Int. Cl. B01L 3/02

(52) U.S. Cl. CPC B01L 3/0268; B01L 2300/0829; B01L 2400/0439

(57) ABSTRACT

A microdroplet ejection apparatus is provided, the apparatus including an inlet port through which a suspension is movable in one direction, a nozzle including a nozzle cover connected to the inlet port and formed of a transparent material, a nozzle body connected to the nozzle cover and configured to eject the suspension, and a nozzle base formed of a transparent material and provided on an opposite side of the nozzle cover with respect to the nozzle body, an outlet port connected to the nozzle cover and configured to emit the suspension remaining after the suspension is ejected from the nozzle from the suspension to an outside of the nozzle, and a piezo actuator attached to one surface of the nozzle cover or one surface of the nozzle base and driven so that the suspension ejects from the nozzle body by applying pressure to the attached surface.

### CROSS-REFERENCE TO RELATED APPLICATION

This application claims the benefit of Korean Patent Application No. 10-2023-0018037 filed on Feb. 10, 2023, in the Korean Intellectual Property Office, the entire disclosure of which is incorporated herein by reference for all purposes.

### BACKGROUND

### 1. Field of the Invention

One or more embodiments relate to a microdroplet ejection apparatus. Particularly, the present disclosure is basically manufactured for the purpose of printing, like existing commercial inkjet equipment. The existing commercial inkjet equipment is mainly used for the purpose of printing on a paper using dye ink. The purpose of the present disclosure is to advance one step further than the existing dye ink and provide an apparatus that may eject ink containing nanoparticles or biomaterials mixed in a dispersion solvent.

Recently, inkjet equipment ejects ink including nanoparticles, and thus, research on bottom-up fabrication has been actively conducted. The bottom-up fabrication is currently in the spotlight as technology that may be applied to a next-generation display or a next-generation semiconductor process. In addition, the inkjet equipment is also applied to bioprinting technology, which is utilized for purposes such as cell culture and production of artificial organs by mixing biomaterials with the ink.

### 2. Description of the Related Art

The purpose of inkjet equipment is to produce uniform droplets. There are two main methods of producing uniform droplets. The first method is a continuous inkjet method, which continuously produces uniform droplets by applying strong positive pressure to inkjet equipment. The second method is a drop-on-demand (DoD) method, which produces droplets of the desired droplet size at the time a user intends to produce droplets by applying pressure to the inside of the inkjet equipment in a state that a nozzle contains a liquid. Among the DoD methods, the present disclosure uses a piezoelectric DoD method, which is a method of applying pressure utilizing a piezoelectric element.

In the case of the related art, inkjet equipment is used for printing by ejecting pure dye ink without any substances mixed in the ink. As previously described, many studies on bottom-up fabrication or bioprinting are conducted to eject uniform droplets by mixing nanoparticles or biomaterials in a liquid as one of the experimental methodologies. In such case, since nanoparticle suspension ink or bio-ink is ejected by utilizing commercial inkjet equipment used for ejecting existing dye ink, many issues arise from ejecting uniform droplets.

For example, in the case of most commercial inkjet equipment, thousands of nozzles are mounted in one system, and there is a disadvantage that the inside of the equipment is not visible. Therefore, determining the exact cause of the non-uniform droplet production is difficult, because it is difficult to determine whether the nanoparticles block the nozzle and prevent the droplets from being ejected or whether the droplets are not ejected straight due to particles stuck near the nozzle surface. Therefore, a transparent inkjet nozzle is necessary.

In addition, inkjet equipment for the research purpose that is relatively inexpensive compared to commercial inkjet equipment is also necessary.

Korean Patent Application No. 2010-0043481 discloses a technical idea related to a method of manufacturing an inkjet head.

### SUMMARY

One or more embodiments are to provide a microdroplet ejection apparatus with a transparent ejection channel that may show internal flow.

One or more embodiments are to provide a microdroplet ejection apparatus with an ejection channel that may be manufactured to have various shapes and diameters.

One or more embodiments are to provide a microdroplet ejection apparatus that may use a piezoelectric element with a size of several millimeters (mm) as a pressure source.

One or more embodiments are to provide a microdroplet ejection apparatus that may eject ink with high viscosity including nanoparticles or biomaterials.

According to an aspect, there is provided a microdroplet ejection apparatus, the apparatus including an inlet port through which a suspension is movable in one direction, a nozzle including a nozzle cover connected to the inlet port and formed of a transparent material, a nozzle body connected to the nozzle cover and configured to eject the suspension, and a nozzle base formed of a transparent material and provided on an opposite side of the nozzle cover with respect to the nozzle body, an outlet port connected to the nozzle cover and configured to emit the suspension remaining after the suspension is ejected from the nozzle from the suspension to an outside of the nozzle, and a piezo actuator attached to one surface of the nozzle cover or one surface of the nozzle base and driven so that the suspension ejects from the nozzle body by applying pressure to the attached surface.

The nozzle cover may include a cover plate and an inlet hole and an outlet hole formed through the cover plate and overlapping the inlet port and the outlet port, respectively.

The nozzle body may include a body plate configured to support the cover plate, a flow channel formed through the body plate, one end and the other end of the flow channel overlapping the inlet hole and the outlet hole, respectively, and an ejection channel formed by extending from the flow channel.

The ejection channel may be formed in a direction crossing a longitudinal direction of the flow channel.

The piezo actuator may overlap the flow channel with respect to a direction in which the nozzle base, the nozzle body, and the nozzle cover are stacked.

A length of the piezo actuator attached to the nozzle may be adjustable in a longitudinal direction of the flow channel.

At least a portion of the ejection channel may not overlap the piezo actuator with respect to a direction in which the nozzle cover, the nozzle body, and the nozzle base are stacked.

The piezo actuator may be maintained in a shape parallel to the nozzle body in an initial state in which a voltage is not applied, and a central portion of the piezo actuator changes into a shape curving outward toward the nozzle body so that the piezo actuator applies pressure to a portion of the nozzle cover or to a portion of the nozzle base to which the piezo actuator is attached, in an actuation state in which a voltage is applied.

The piezo actuator may be provided as a pair, the pair of piezo actuators being respectively attached to the nozzle cover and nozzle base.

The pair of piezo actuators may have a same phase in an initial state in which a voltage is not applied.

The nozzle may be detachably connected to the inlet port and the outlet port.

Additional aspects of embodiments will be set forth in part in the description which follows and, in part, will be apparent from the description, or may be learned by practice of the disclosure.

According to embodiments, a microdroplet ejection apparatus may have a transparent ejection channel that may show internal flow.

According to embodiments, a microdroplet ejection apparatus may have an ejection channel that may be manufactured to have various shapes and diameters.

According to embodiments, a microdroplet ejection apparatus may use a piezoelectric element with a size of several mm as a pressure source.

According to embodiments, a microdroplet ejection apparatus may eject ink with high viscosity including nanoparticles or biomaterials.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram schematically illustrating a microdroplet ejection apparatus according to an embodiment;

FIGS. 2A and 2B are exploded perspective views illustrating a nozzle cover, a nozzle body, and a nozzle base of FIG. 1 according to an embodiment;

FIG. 3 is a plan view illustrating the nozzle body of FIG. 1 according to an embodiment;

FIGS. 4A to 4C are diagrams illustrating an initial state and an actuation state of a piezo actuator of FIG. 1 according to an embodiment;

FIGS. 5A and 5B are plan views schematically illustrating piezo actuators with different lengths in the longitudinal direction of a flow channel, according to an embodiment;

FIG. 6 is a diagram illustrating various shapes of an ejection channel according to an embodiment;

FIG. 7 is a perspective view illustrating a state in which an additional piezo actuator is attached to a nozzle base according to an embodiment; and

FIG. 8 is a graph illustrating ejection speed with respect to volume percentage of ethylene glycol in demineralized water in a microdroplet ejection apparatus including different numbers of piezo actuators according to an embodiment.

### DETAILED DESCRIPTION

The following detailed structural or functional description is provided as an embodiment only and various alterations and modifications may be made to embodiments. Accordingly, embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

The same name may be used to describe an element included in the embodiments described above and an element having a common function. Unless otherwise described, the description on one embodiment may be applicable to another embodiment and thus, redundant description will be omitted for conciseness.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, regardless of drawing numerals, like reference numerals refer to like elements and a repeated description related thereto will be omitted.

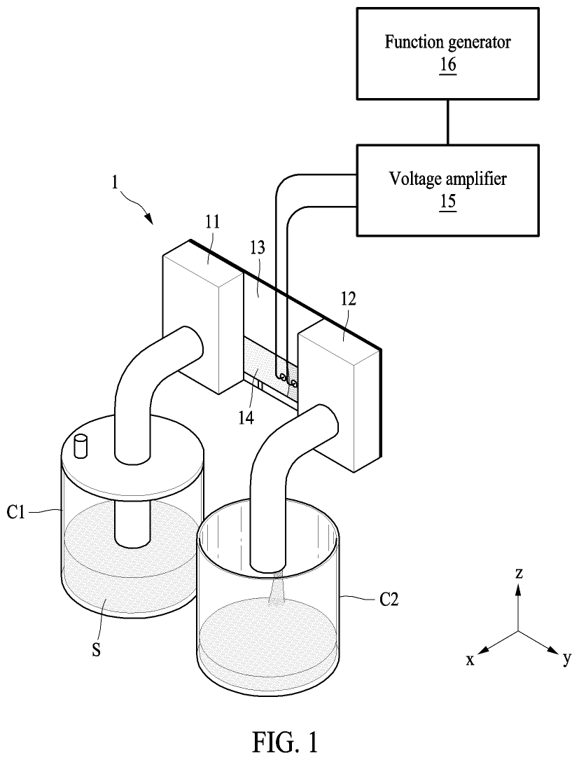

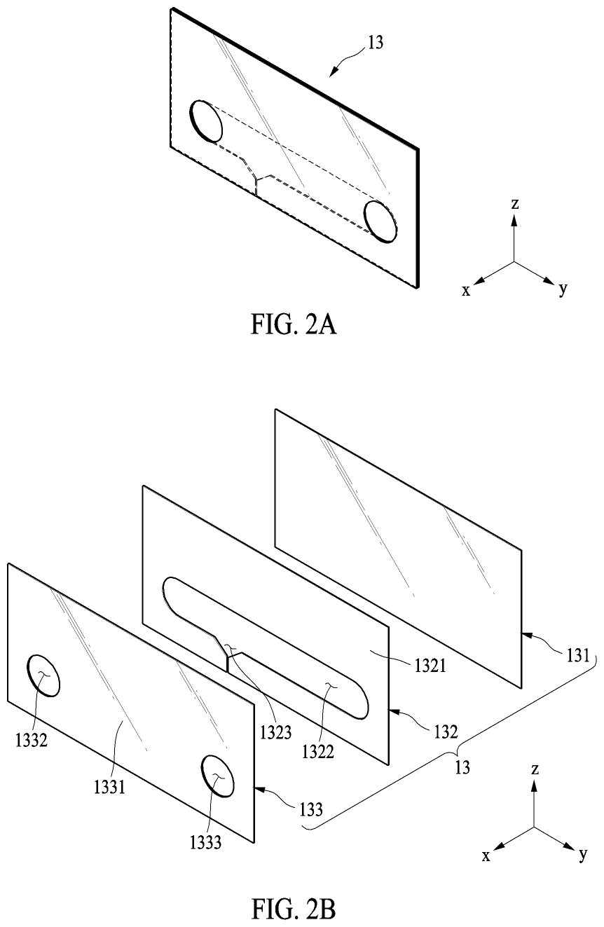

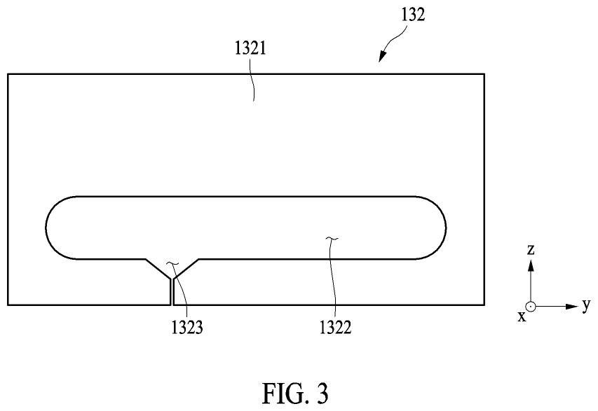

FIG. 1 is a diagram schematically illustrating a microdroplet ejection apparatus according to an embodiment. FIG. 2A and 2B are exploded perspective views illustrating a nozzle cover, a nozzle body, and a nozzle base of FIG. 1 according to an embodiment, and FIG. 3 is a plan view illustrating the nozzle body of FIG. 1 according to an embodiment.

Referring to FIGS. 1 to 3, according to an embodiment, a microdroplet ejection apparatus 1 may eject a portion of a suspension S flowing in one direction in a form of microdroplets. For example, the suspension S may be a nanoparticle-suspension including nanoparticles or biomaterials in a solvent.

Two different containers C1 and C2 may each be connected to the microdroplet ejection apparatus 1. Before the suspension S flows into the microdroplet ejection apparatus 1, the suspension S may be in a state where the suspension S is contained in any one container (e.g., the container C1) of the two containers. The suspension S may flow from any one container (e.g., the container C1) to another container (e.g., the container C2) through the microdroplet ejection apparatus 1. For example, the suspension S may flow using pressure differences.

While the suspension S moves in one direction within a channel of a nozzle 13 formed of a transparent material, a pressure source may receive an electrical signal and may apply pressure to the nozzle 13. The suspension S may be ejected from the nozzle 13 in the form of microdroplets, and a user may visually check whether droplets are uniformly ejected by observing the flow of the suspension S within the nozzle 13. The microdroplet ejection apparatus 1 may include an inlet port 11, an outlet port 12, a nozzle 13, and a piezo actuator 14.

The inlet port 11 and the outlet port 12 may each be connected to the same surface of the nozzle 13. For example, the inlet port 11 and the outlet port 12 may have the same shape. The inlet port 11 may provide a passage through which the suspension S flows from the container C1 containing the suspension S to the nozzle 13. The outlet port 12 may provide a passage for ejecting the suspension S remaining after the suspension S is ejected from the nozzle 13 to the outside of the nozzle 13. For example, nitrogen gas with low-reactivity and the like may be injected into the container C1 connected to the inlet port 11. The pressure inside the container C1 may increase, and the suspension S may flow from the container C1 to the inlet port 11.

The nozzle 13 may be pressured by the piezo actuator 14 and may eject a portion of the suspension S flowed from the inlet port 11 to the outside. As shown in FIGS. 2A and 2B, the nozzle 13 may include a nozzle base 131, a nozzle body 132, and a nozzle cover 133.

The nozzle base 131 may be formed of a transparent material. For example, the nozzle base 131 may be formed of glass. The nozzle body 132 may be stacked on the nozzle base 131. The nozzle cover 133 may be stacked on the nozzle body 132. The nozzle body 132 may be positioned between the nozzle base 131 and the nozzle cover 133. Both surfaces of the nozzle body 132 may be covered by the nozzle base 131 and the nozzle cover 133, respectively. From such a structure, the suspension S may flow in one direction within the nozzle 13 with respect to any shape formed through the nozzle body 132.

The nozzle cover 133 may include a cover plate 1331, an inlet hole 1332, and an outlet hole 1333. The inlet hole 1332 and the outlet hole 1333 are formed through the cover plate 1331. The cover plate 1331 may be formed of a transparent material. For example, the cover plate 1331 may be formed of glass. For example, the cover plate 1331 may be formed of the same material as the nozzle base 131. The inlet hole 1332 and the outlet hole 1333 may overlap the inlet port 11 and the outlet port 12, respectively.

The nozzle body 132 may include a body plate 1321, a flow channel 1322, and an ejection channel 1323. The flow channel 1322 and the ejection channel 1323 are formed through the body plate 1321. The body plate 1321 may support the cover plate 1331. For example, the body plate 1321 may be formed of silicon.

One end and the other end of the flow channel 1322 may overlap the inlet hole 1332 and the outlet hole 1333, respectively, based on the direction in which the nozzle cover 133 is stacked on the nozzle body 132. A portion of the flow channel 1322 excluding the area overlapping the inlet hole 1332 and the outlet hole 1333 may be provided between the nozzle base 131 and the cover plate 1331, based on the direction in which the nozzle cover 133 is stacked on the nozzle body 132.

The ejection channel 1323 may extend from the flow channel 1322. The suspension S may be ejected to the outside of the nozzle 13 in the form of microdroplets through the ejection channel 1323. The ejection channel 1323 may be formed in the direction crossing the longitudinal direction of the flow channel 1322. For example, the ejection channel 1323 may be formed to extend in the direction perpendicular to the longitudinal direction of the flow channel 1322. From such a structure, while microdroplets are ejected from the nozzle body 132, the effect of the suspension S flowing in the longitudinal direction of the flow channel 1322 may be reduced.

The piezo actuator 14 may be attached to one surface of the nozzle base 131 or one surface of the nozzle cover 133. Hereinafter, the piezo actuator 14 is described based on the case where the piezo actuator 14 is attached to the nozzle cover 133, as shown in FIG. 1. A positive electrode and a negative electrode of the piezo actuator 14 may be connected to a voltage amplifier 15. The voltage amplifier 15 may apply the voltage and waveform input from a function generator 16 to the piezo actuator 14.

The piezo actuator 14 may change the shape when a voltage is applied and may be driven to apply pressure to the flow channel 1322. The piezo actuator 14 may have an initial state in which a voltage is not applied and an actuation state in which a voltage is applied. The piezo actuator 14 may be maintained in a shape parallel to the nozzle body 132 in the initial state. In the actuation state, the central portion of the piezo actuator 14 may change into a shape curving outward toward the nozzle base 131 and may apply pressure to a portion of the nozzle cover 133. A portion of the suspension S within the flow channel 1322 may be pressed by the piezo actuator 14 to flow from the flow channel 1322 to the ejection channel 1323.

The piezo actuator 14 may be an apparatus manufactured as a buzzer. The piezo actuator 14 may have a size of several millimeters (mm). In an embodiment, a CEB-35D26 model may be used as the piezo actuator 14. Compared to the case of using an existing pressure source with a size of several tens of micrometers (μm), the production cost of the microdroplet ejection apparatus 1 may be reduced.

Based on the direction in which the nozzle cover 133 is stacked on the nozzle body 132, the piezo actuator 14 may overlap at least a portion of the flow channel 1322 and may not overlap at least a portion of the ejection channel 1323. From such a structure, the user may observe the flow of the suspension S within the ejection channel 1323. The user may check whether microdroplets of the suspension S are uniformly ejected from the ejection channel 1323.

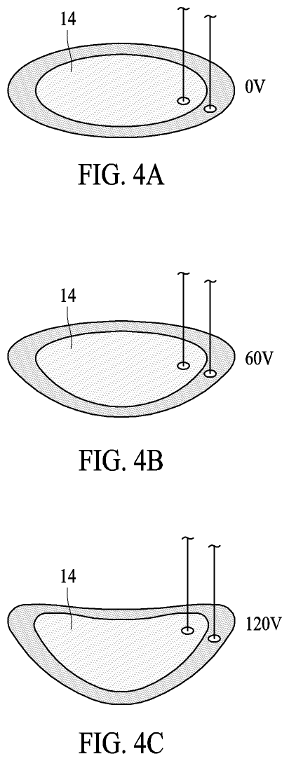

FIGS. 4A to 4C are diagrams illustrating an initial state and an actuation state of the piezo actuator of FIG. 1 according to an embodiment.

Referring to FIGS. 4A to 4C, according to an embodiment, the degree to which the piezo actuator 14 is deformed may increase as the applied voltage increases. As shown in FIG. 4A, the piezo actuator 14 may be in an initial state where voltage is not applied. As shown in FIG. 4B, the piezo actuator 14 may be in an actuation state with a voltage of 60V applied, and as shown in FIG. 4C, the piezo actuator 14 may be in an actuation state with a voltage of 120V applied.

The user may control the speed of microdroplets ejected from an ejection channel by controlling the magnitude of the voltage applied to the piezo actuator 14. For example, when the magnitude of the voltage applied to the piezo actuator 14 increases, the degree to which the piezo actuator 14 is deformed may increase. The degree to which the piezo actuator 14 applies pressure to a flow channel may increase, and the speed of microdroplets ejected from the ejection channel may increase.

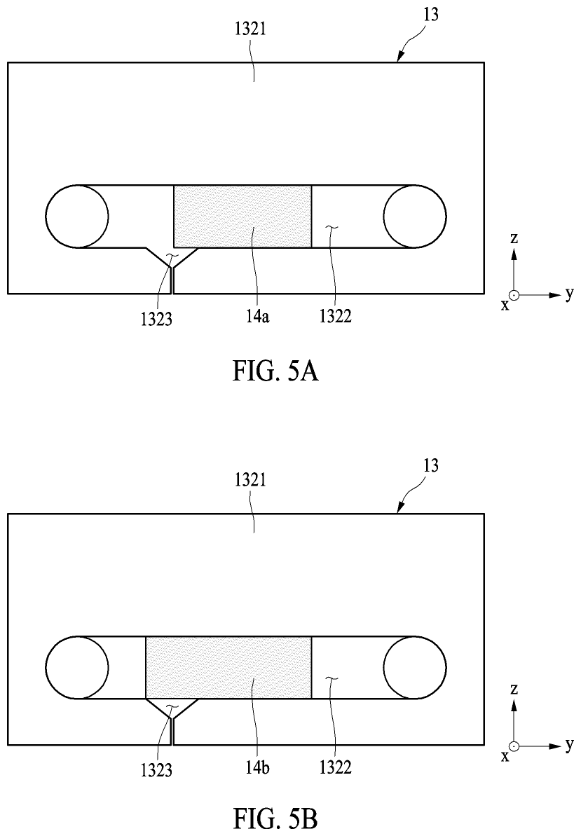

FIGS. 5A and 5B are plan views schematically illustrating piezo actuators with different lengths in the longitudinal direction of a flow channel, according to an embodiment.

Referring to FIGS. 5A and 5B, according to an embodiment, the length of a piezo actuator attached to the nozzle 13 may be adjusted in the longitudinal direction of the flow channel 1322 of a nozzle body. The user may adjust the speed of microdroplets ejected from the ejection channel 1323 by adjusting the length of the piezo actuator. For example, the user may consider the characteristics of a suspension, such as viscosity and density, may cut the piezo actuator to an appropriate length, and then may attach the piezo actuator to a nozzle.

As shown in FIG. 5B, the user may use a piezo actuator 14b, in which the length of the piezo actuator 14b is greater than the length of a piezo actuator 14a shown in FIG. 5A. When the piezo actuator 14b is in an actuation state, the extent that the piezo actuator 14b applies pressure to the flow channel 1322 may increase. The degree to which the flow channel 1322 is deformed may increase, and the amount of a suspension flowing from the flow channel 1322 to the ejection channel 1323 may increase. The speed of microdroplets ejected from the ejection channel 1323 may increase.

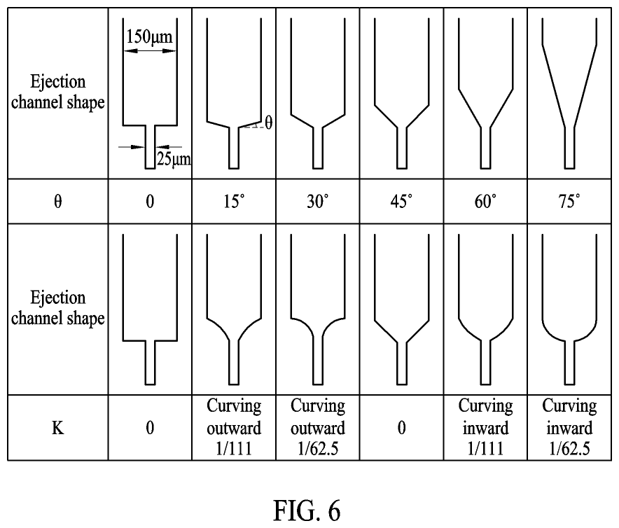

FIG. 6 is a diagram illustrating various shapes of an ejection channel according to an embodiment.

Referring to FIG. 6, according to an embodiment, an ejection channel of a nozzle body may be designed to have various shapes. For example, an angle θ at which an ejection channel narrows in the direction in which a suspension flows within the ejection channel and the curvature K of the ejection channel may be designed differently depending on the type of suspension used. From such a structure, uniform ejection of microdroplets may be achieved from a suspension in which ejection of microdroplets does not proceed or uniform ejection of microdroplets does not proceed.

In an embodiment, a nozzle may be detachably connected to an inlet port and an outlet port. To eject microdroplets of a suspension with different properties, only nozzles including ejection channels with different shapes may be replaced. The production cost of a microdroplet ejection apparatus may be reduced, and the utilization of the microdroplet ejection apparatus may be increased.

In FIG. 6, the size of the diameter of the ejection channel is shown to be narrowed from 150 μm to 25 μm, but the size of the diameter of the ejection channel is not limited thereto.

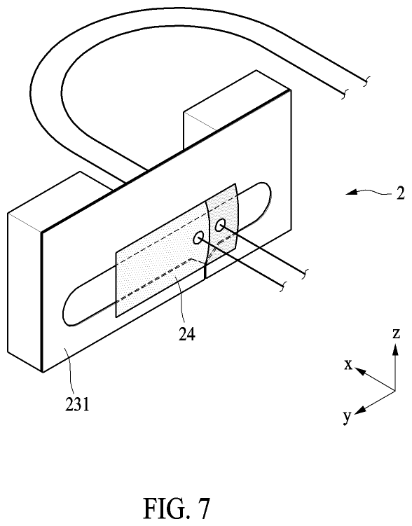

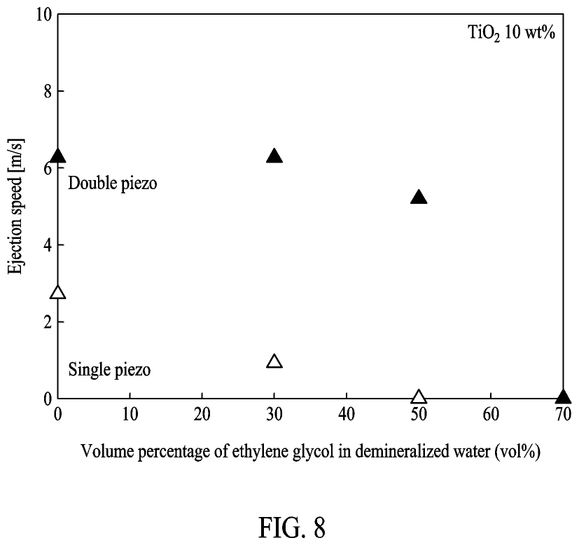

FIG. 7 is a perspective view illustrating a state in which an additional piezo actuator is attached to a nozzle base according to an embodiment, and FIG. 8 is a graph illustrating ejection speed with respect to volume percentage of ethylene glycol in demineralized water in a microdroplet ejection apparatus including different numbers of piezo actuators according to an embodiment.

Referring to FIGS. 7 and 8, according to an embodiment, a microdroplet ejection apparatus 2 may include a pair of piezo actuators. The pair of piezo actuators may be attached to a nozzle cover and a nozzle base 231, respectively. For example, the pair of piezo actuators may be connected to the same voltage amplifier. For better understanding, FIG. 7 shows a piezo actuator 24 attached to the nozzle base 231 of the pair of piezo actuators and the other piezo actuator attached to the nozzle cover is hidden by a nozzle so that the other piezo actuator is not visible.

When the pair of piezo actuators is driven, a suspension with a relatively high viscosity may be ejected. The pair of piezo actuators may be provided facing each other with respect to a flow channel, and the phases of the pair of piezo actuators may be the same. The pair of piezo actuators may both have an initial state or may both have an actuation state. For example, the pair of piezo actuators may each be maintained in a shape parallel to a nozzle in the initial state. In the actuation state, the central portions of the pair of piezo actuators may each change into a shape curving outward toward a nozzle body and may apply pressure to the flow channel. Compared to the case of using one piezo actuator, the degree to which the pair of piezo actuators applies pressure to the flow channel may be increased. The speed of microdroplets ejected from the flow channel may be increased.

As shown in FIG. 8, in an embodiment, a solution including 10 wt % of ethylene glycol and titanium dioxide (TiO₂) in demineralized water may be used as a suspension. When the volume percentages of ethylene glycol in demineralized water are 0% and 30%, the speed of microdroplets pressed and ejected by a pair of piezo actuators may be confirmed to be more than twice the speed of microdroplets pressed and ejected by one piezo actuator.

When the volume percentage of ethylene glycol in demineralized water is 50%, microdroplets that are not ejected when pressed by one piezo actuator may be confirmed to be ejected when pressed by a pair of piezo actuators.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A microdroplet ejection apparatus comprising:
an inlet port through which a suspension is movable in one direction;
a nozzle comprising a nozzle cover connected to the inlet port and formed of a transparent material, a nozzle body connected to the nozzle cover and configured to eject the suspension, and a nozzle base formed of a transparent material and provided on an opposite side of the nozzle cover with respect to the nozzle body;
an outlet port connected to the nozzle cover and configured to emit the suspension remaining after the suspension is ejected from the nozzle from the suspension to an outside of the nozzle; and
a piezo actuator attached to one surface of the nozzle cover or one surface of the nozzle base and driven so that the suspension ejects from the nozzle body by applying pressure to the attached surface.

2. The microdroplet ejection apparatus of claim 1, wherein
the nozzle cover comprises:
a cover plate; and
an inlet hole and an outlet hole formed through the cover plate and overlapping the inlet port and the outlet port, respectively.

3. The microdroplet ejection apparatus of claim 2, wherein
the nozzle body comprises:
a body plate configured to support the cover plate;
a flow channel formed through the body plate, one end and the other end of the flow channel overlapping the inlet hole and the outlet hole, respectively; and
an ejection channel formed by extending from the flow channel.

4. The microdroplet ejection apparatus of claim 3, wherein
the ejection channel is formed in a direction crossing a longitudinal direction of the flow channel.

5. The microdroplet ejection apparatus of claim 3, wherein
the piezo actuator overlaps the flow channel with respect to a direction in which the nozzle base, the nozzle body, and the nozzle cover are stacked.

6. The microdroplet ejection apparatus of claim 3, wherein
a length of the piezo actuator attached to the nozzle is adjustable in a longitudinal direction of the flow channel.

7. The microdroplet ejection apparatus of claim 3, wherein
at least a portion of the ejection channel does not overlap the piezo actuator with respect to a direction in which the nozzle cover, the nozzle body, and the nozzle base are stacked.

8. The microdroplet ejection apparatus of claim 1, wherein
the piezo actuator is maintained in a shape parallel to the nozzle body in an initial state in which a voltage is not applied, and a central portion of the piezo actuator changes into a shape curving outward toward the nozzle body so that the piezo actuator applies pressure to a portion of the nozzle cover or to a portion of the nozzle base to which the piezo actuator is attached, in an actuation state in which a voltage is applied.

9. The microdroplet ejection apparatus of claim 1, wherein
the piezo actuator is provided as a pair, the pair of piezo actuators being respectively attached to the nozzle cover and nozzle base.

10. The microdroplet ejection apparatus of claim 9, wherein
the pair of piezo actuators has a same phase in an initial state in which a voltage is not applied.

11. The microdroplet ejection apparatus of claim 1, wherein
the nozzle is detachably connected to the inlet port and the outlet port.
